(19) United States
(12) Patent Application Publication
(10) Pub. No.: US 2026/0106374 A1
(43) Pub. Date: Apr. 16, 2026

(54) META-SURFACE RECONFIGURABLE ANTENNA ARRAY

(71) Applicant: Novocomms Ltd., Birmingham (GB)

(72) Inventors: Zhenhua Hu, Birmingham (GB); Qingling Yang, Birmingham (GB)

(21) Appl. No.: 19/116,243

(22) PCT Filed: Sep. 25, 2023
(86) PCT No.: PCT/GB2023/052478

§ 371 Date: Mar. 27, 2025

(30) Foreign Application Priority Data
Sep. 28, 2022 (GB) 2214201.2
Jul. 27, 2023 (GB) 2311547.0
Jul. 27, 2023 (WO) PCT/EP2023/070939

(51) Int. Cl. H01Q 3/36; H01Q 15/10

(52) U.S. Cl. CPC H01Q 3/36; H01Q 15/10

(57) ABSTRACT

There is disclosed a reconfigurable antenna array comprising an RF feed, configured to receive RF signals from an RF source; a plurality of waveguide feed structures, each waveguide feed structure comprising a plurality of unit cells arranged end-to-end, each unit cell configured to transmit RF signals out of the unit cell; and an RF power distributor, operatively connected to said RF feed, configured to split the received RF signals into multiple channels and to allocate different channels to different respective waveguide feed structures, wherein each waveguide feed structure is configured to guide the RF signals of the channel allocated to the waveguide structure to the unit cells of the waveguide feed structure. Each unit cell comprises reconfigurable components configured to manipulate electromagnetic properties of the RF signals received by the RF feed and guided along the respective waveguide structure so as to control a radiation pattern of the antenna array.

This application is a national stage entry of WO International Patent Application No. PCT/GB2023/052478, filed 25 Sep. 2023, which claims priority to GB Patent Application No. 2214201.2, filed 28 Sep. 2022; GB Patent Application No. 2311547.0, filed 27 Jul. 2023; and WO International Patent Application No. PCT/EP2023/070939, filed 27 Jul. 2023. The entire contents of each of the above-mentioned applications is incorporated herein by reference.

### TECHNICAL FIELD

This disclosure relates to a reconfigurable antenna array. The reconfigurable antenna array may be useful for beam steering and beam scanning applications.

### BACKGROUND

Mobile and telecommunications devices are becoming more complex and demanding in the way they use the available spectrum, especially in the bands between 10-300 GHz. These bands of spectrum are being utilised for the next-generation of mobile communications, known as 5G (fifth-generation) or 6G (sixth-generation), satellite communications and certain automobile radars used in in guidance, safety, and also automobile communications and entertainment systems. This spectrum has lots of demanding uses such as ability to support very fast services, increasing existing 4G bandwidth, and short-range effectiveness allowing frequency re-use, which all make increasing complexity on the control and operation of antennas in this regime.

Current antenna designs operating at these frequencies are required to utilise beam-steering capabilities to maximise the potential of such communications. Traditional methods of beam steering using antenna element arrays uses a technique called phased array. By adjusting the feeding phase of each antenna element and the constructive and destructive interference from each wavelet creates a steerable wavefront. However, such systems require complex phase-shifting electronics controls and feeding networks which increases the costs and complexity.

A newer technology for beam-steering uses what is known as a controllable reconfigurable meta-surface. These devices use a metamaterial which is an artificial structure comprised of repeating unit cells arranged to provide particular properties. Such materials are already well known in photonics. Each unit cell of the meta-surface can be reconfigured or structured to adjust properties of the emitted wave, this can be through passive structural type arrangements, or using components such as reconfigurable elements e.g. diodes, varactors, liquid crystals (LCDs), graphene, or microelectromechanical system (MEMS) switch, etc. This method is much more flexible, lower cost and lower power than traditional phase shifting techniques.

Although meta-surface antenna arrays provide many advantages over traditional phased arrays, they still have some drawbacks. For example, they require a large number of reconfigurable components, and each of these reconfigurable components has to be addressed by some circuitry to operate. Implementations using liquid-crystal technologies can make the antenna slow to beam steer, due to their slow response and also have a potentially large footprint, depending on the preciseness of the beam-steer required.

Another problem is that each unit cell of the meta-surface needs to be synchronised with the others and also receive a signal at the same time. This can be challenging in large and complex meta-surfaces, such as those required for satellite uplink especially.

An example of a leaky-wave meta-surface antenna arrangement can be found in the co-pending UK patent application No. 2211127.2 which describes a unit cell structure and associated reconfigurable element arrangement to enable solutions to some of the above problems. However, the problem of size, complexity and cost of creating an array with acceptable 2-d beam steering properties is still a challenge, as are any feeding arrangements. Also, complex arrays can also suffer from high-loss and low efficiencies.

### SUMMARY

According to one aspect of the disclosure, a reconfigurable antenna array includes:
i) a radio frequency, RF, feed, configured to receive RF signals from an RF source;
ii) a plurality of waveguide feed structures, each waveguide feed structure comprising a plurality of unit cells arranged end-to-end, each unit cell configured to transmit RF signals out of the unit cell;
iii) an RF power distributor, operatively connected to said RF feed, configured to split the received RF signals into multiple channels and to allocate different channels to different respective waveguide feed structures, wherein each waveguide feed structure is configured to guide the RF signals of the channel allocated to the waveguide structure to the unit cells of the waveguide feed structure;
iv) wherein each unit cell comprises reconfigurable components configured to manipulate electromagnetic properties of the RF signals received by the RF feed and guided along the respective waveguide structure so as to control a radiation pattern of the antenna array.

The unit cells may be arranged end-to-end in a substantially linear array. In some examples, the unit cells may be arranged end-to-end in a straight line linear array. In other examples, the unit cells may be arranged end-to-end along a non-straight or curved line.

The reconfigurable antenna array may further comprise at least one variation network between the RF feed and the plurality of waveguide feed structures, wherein adjustment of the at least one variation network modifies properties of the RF signals so as to provide further control of the radiation pattern of the antenna array.

The reconfigurable antenna array may further comprise a plurality of parallel variation networks between the RF feed and the plurality of waveguide feed structures, wherein adjustment of the variation networks modifies properties of the RF signals so as to provide further control of the radiation pattern of the antenna array.

The or each variation network may be configurable to change a phase, or an amplitude, or both a phase and an amplitude, of an RF signal passing therethrough.

The or each variation network may comprise at least one component selected from: phase shifters, attenuators, RF switches, power amplifiers, low-noise amplifiers and combinations thereof.

Each variation network may be configured for a particular frequency band.

The variation networks may be discrete variation networks, and may this be simple in design.

The reconfigurable antenna array may further comprise an additional RF power distributor, operatively connected between the RF feed and the plurality of parallel variation networks, configured to split the received RF signals into multiple channels and to allocate different channels to different respective variation networks of the plurality of parallel variation networks.

Each waveguide feed structure may be connected to a respective one of the plurality of parallel variation networks.

Each waveguide feed structure may comprise a metallic base wall and a metallic top wall substantially parallel to the base wall, and may be provided with a periodic pattern of apertures, the waveguide feed structure defining a substantially linear cavity with first and second ends.

Each waveguide feed structure may further comprise first and second substantially parallel metallic side walls that disposed substantially perpendicular to the base wall and the top wall.

The first and second substantially parallel metallic side walls may have a height, h, and a mutual separation distance, d. Advantageously, h>d, optionally h>2d, optionally h>3d, optionally h>4d. Advantageously, each waveguide feed structure is configured as a narrow wall waveguide feed structure with h>d, optionally h>2d, optionally h>3d, optionally h>4d.

The unit cells may be configured to transmit RF signals through the apertures.

The reconfigurable components of the unit cells may be in an upper electromagnetic metasurface layer disposed above the metallic top wall.

The reconfigurable components of the unit cells may be in a lower electromagnetic metasurface layer disposed on or adjacent to the metallic base wall.

The reconfigurable components of the unit cells may be in both an upper electromagnetic metasurface layer disposed above the metallic top wall and in a lower electromagnetic metasurface layer disposed on or adjacent to the metallic base wall.

The reconfigurable components of the unit cells may comprise at least one of switchable conductive patches, switchable slots, microelectromechanical (MEMS) elements, nanoelectromechanical (NEMS) elements, chiral change elements, and liquid crystal elements.

The reconfigurable components may be configured to be switchable between at least a first state and a second state, the first state interacting with and modifying the RF signals differently to the second state.

The waveguide feed structures may be arranged substantially parallel to each other so as to define a two dimensional array of unit cells arranged in rows and columns.

The reconfigurable components of each unit cell may be controllably addressable by row, or by column, or by both row and column.

Adjacent waveguide feed structures may be fed with RF signals in different frequency bands. For example, the waveguide feed structures may be interdigitated, with alternate waveguide feed structures fed with RF signals in a first frequency band, separated by waveguide feed structures fed with RF signals in a second frequency band.

More generally, different ones of the waveguide structures may be fed with RF signals in different frequency bands. The waveguide structures may be fed by way of variation networks configured or tailored for optimal operation in the relevant frequency band.

Each waveguide feed structure may be a grounded waveguide feed structure comprising a metallic base wall and a metallic top wall substantially parallel to the base wall, and provided with a periodic pattern of apertures, the waveguide structure defining a substantially linear cavity with first and second ends; an upper electromagnetic metasurface layer disposed over the metallic top wall, the upper electromagnetic metasurface layer comprising a series of reconfigurable components configured to interact with and modify a property of RF signals passing through the upper electromagnetic metasurface layer; wherein the waveguide structure is configured to guide the RF signals along the substantially linear cavity such that RF signals emanating through the apertures of the periodic pattern of apertures in the metallic top wall couple with the series of reconfigurable components of the upper electromagnetic metasurface layer so as to modify the RF signals emanating through the apertures.

Each waveguide feed structure may be a grounded waveguide structure comprising a metallic base wall and a metallic top wall substantially parallel to the base wall, and provided with a periodic pattern of apertures, the waveguide structure defining a substantially linear cavity with first and second ends; an upper electromagnetic metasurface layer disposed over the metallic top wall, the upper electromagnetic metasurface layer comprising a series of reconfigurable components configured to interact with and modify a property of RF signals passing through the upper electromagnetic metasurface layer; a lower electromagnetic metasurface layer disposed on or adjacent to the base wall within the substantially linear cavity, the lower electromagnetic metasurface layer comprising a series of reconfigurable components configured to interact with and modify a property of RF signals incident upon and reflected by the lower electromagnetic metasurface layer; wherein the waveguide structure is configured to guide the RF signals along the substantially linear cavity such that RF signals emanating through the apertures of the periodic pattern of apertures in the metallic top wall couple with the series of reconfigurable components of the upper electromagnetic metasurface layer so as to modify the RF signals emanating through the apertures, and wherein the waveguide structure is configured to guide the RF signals along the substantially linear cavity such that RF signals incident upon the lower electromagnetic metasurface layer interact with and are modified by the series of reconfigurable components and reflected towards and through the apertures in the top wall of the substantially linear waveguide.

Each waveguide feed structure may be a grounded waveguide structure comprising a metallic base wall and a metallic top wall substantially parallel to the base wall, and provided with a periodic pattern of apertures, the waveguide structure defining a substantially linear cavity with first and second ends; a lower electromagnetic metasurface layer disposed on or adjacent to the base wall within the substantially linear cavity, the lower electromagnetic metasurface layer comprising a series of reconfigurable components configured to interact with and modify a property of RF signals incident upon and reflected by the lower electromagnetic metasurface layer; wherein the waveguide structure is configured to guide RF signals along the substantially linear cavity such that RF signals incident upon the lower electromagnetic metasurface layer interact with and are modified by the series of reconfigurable components and reflected towards and through the apertures in the top wall of the substantially linear waveguide.

The RF signals may propagate along the waveguide structure as a travelling wave.

The series of reconfigurable components in the upper electromagnetic metasurface layer may be in registration with the periodic pattern of apertures in the top wall. This means that each reconfigurable component in the upper electromagnetic metasurface layer is disposed above or adjacent to a corresponding aperture in the top wall, for example in an overlapping arrangement when viewed from directly above.

The series of reconfigurable components in the lower electromagnetic metasurface layer may be in registration with the periodic pattern of apertures in the top wall. This means that each reconfigurable component in the lower electromagnetic metasurface layer is disposed under a corresponding aperture in the top wall, on the bottom of the linear cavity, for example in an overlapping arrangement when viewed from directly above.

The series of reconfigurable components in the upper and/or in the lower electromagnetic metasurface layer may comprise active, reconfigurable elements. For example, the reconfigurable components may comprise at least one of switchable conductive patches, switchable slots, microelectromechanical (MEMS) elements, nanoelectromechanical (NEMS) elements, chiral change elements, and liquid crystal elements. The active, reconfigurable elements may be configured to be switchable between at least a first state and a second state, the first state interacting with and modifying the RF energy differently to the second state.

The antenna array may further comprise control circuitry to reconfigure the active, reconfigurable components of the upper electromagnetic metasurface layer so as controllably to modify RF signals passing through the upper electromagnetic metasurface layer from the apertures in the top wall of the substantially linear waveguide. For example, the control circuitry may apply a bias voltage or bias current that can selectively be switched on or off for selected active reconfigurable components in order to switch the selected active reconfigurable components from the first state to the second state or from the second state to the first state. The active reconfigurable components may be individually switched by the control circuitry, or may be switched together in groups.

The antenna array may further comprise control circuitry to reconfigure the active, reconfigurable components of the lower electromagnetic metasurface layer so as controllably to modify RF signals incident upon the lower electromagnetic metasurface layer and reflected towards the apertures in the top wall of the substantially linear waveguide. For example, the control circuitry may apply a bias voltage or bias current that can selectively be switched on or off for selected active reconfigurable components in order to switch the selected active reconfigurable components from the first state to the second state or from the second state to the first state. The active reconfigurable components may be individually switched by the control circuitry, or may be switched together in groups.

The upper electromagnetic metasurface layer and the lower electromagnetic metasurface layer may be controlled by the same control circuitry. The upper electromagnetic metasurface layer and the lower electromagnetic metasurface layer may be controlled by different control circuitries.

The active, reconfigurable components of the upper and/or the lower electromagnetic metasurface layer may each comprise a conductive patch and a switchable component connecting the conductive patch to ground. This enables switching between a first state and a second state by way of selectively connecting the conductive patch to ground or disconnecting the conductive patch from ground. The switchable component may be selected from the group consisting of: diodes, semiconductor diodes, PIN diodes, MEMS devices, NEMS devices, varactors, varicap diodes, varactor diodes, tuning diodes, liquid crystal switches, liquid metal switches, and phase change material switches.

The modification of the RF signals may comprise polarisation modification. For example, a polarisation angle or a polarisation direction may be modified. For example, linear polarisation may be modified to circular polarisation. For example, left-handed circular polarisation may be modified to right-handed circular polarisation. The desired modification is determined by the elements of the upper and/or the lower electromagnetic metasurface layer(s).

The modification of the RF signals may alternatively, or in addition, comprise phase modification. Different phase shifts may be applied to an RF signal by different reconfigurable components of the upper and/or the lower electromagnetic metasurface layers, for example by appropriate control of active, reconfigurable elements. This may facilitate beam steering.

The apertures in the top wall may be formed as slots. The slots may be angled to a longitudinal axis of the linear cavity at an angle other than 0 degrees or 90 degrees. The slots may all have angled by the same angle. The slots may be angled at different angles. The slots may all have the same length. The slots may all have the same width. The slots may have different lengths. The slots may have different widths.

The grounded waveguide feed structure may further comprise first and second substantially parallel metallic side walls that disposed substantially perpendicular to the base wall and the top wall. This may help to reduce unwanted leakage of RF signals out of the sides of the waveguide structure.

The first and second substantially parallel metallic side walls may have a height, h, and a mutual separation distance, d.

In some examples h>d, optionally h>2d, optionally h>3d, optionally h>4d. These waveguide structures may be considered to be narrow wall waveguides.

The linear waveguide feed structure may be filled with air. Air is less RF lossy than solid or foam dielectric structures that are used in prior art devices, and may allow for more efficient operation.

The linear waveguide feed structure may be filled with a low-loss dielectric. Low-loss materials may allow for more efficient operation than conventional dielectric materials.

In some examples, the linear waveguide feed structure is not filled with any solid or liquid dielectric material. Solid or liquid dielectric materials may introduce unwanted RF losses.

In the context of the present disclosure, the term “electromagnetic metasurface layer” is intended to mean a layer of structured or engineered material comprising a series of elements disposed on or in the layer that are sized and configured to interacts with electromagnetic waves that pass through the layer or that are incident upon and reflected by the layer. Specifically, the electromagnetic metasurface layers employed in the present disclosure are configured for use with RF waves, which typically have a wavelength of the order of centimetres or millimetres. Electromagnetic metasurfaces typically have a subwavelength thickness. The elements disposed on or in the layer should be sized or shaped or sized and shaped with dimensions of a similar order of magnitude to the wavelength of the RF waves, or a smaller order of magnitude to the wavelength of the RF waves. The elements may be arranged with a regular periodicity. The elements may be arranged with an irregular periodicity. The elements may be arranged with a random periodicity. The periodicity should also be of a similar order of magnitude to the wavelength of the RF waves, or a smaller order of magnitude to the wavelength of the RF waves. A one dimensional electromagnetic metasurface layer may comprise a one dimensional linear array or series of elements. A two dimensional electromagnetic metasurface layer may comprise a two dimensional array or series of elements. The elements may take various forms, and may, for example, comprise electrically conductive patches or tracks, which may be printed or etched on a dielectric substrate, or may be formed by laser direct structuring or other techniques.

In some examples, the reconfigurable antenna array may be configured as a leaky-wave antenna array. In some examples, the reconfigurable antenna array may be configured more generally as a travelling wave antenna array.

### BRIEF DESCRIPTION OF THE DRAWINGS

Examples of the disclosure are further described hereinafter with reference to the accompanying drawings.

FIG. 1a shows a meta-surface unit cell arrangement.

FIG. 1b shows a further meta-surface unit cell arrangement.

FIG. 1c shows another meta-surface unit cell arrangement.

FIG. 2 shows a plan view of a meta-surface antenna array and feed structure according to a first example of the present disclosure.

FIG. 3 shows a cross-sectional view of a narrow waveguide fed unit cell according to an example of the present disclosure.

FIG. 4 shows a plan view of a meta-surface antenna array and feed structure according to a second example of the present disclosure.

FIG. 5 shows a plan view of a meta-surface antenna array and feed structure according to a third example of the present disclosure.

FIG. 6 shows an end-on view of the narrow-waveguides and reconfigurable components according to a fourth example of the present disclosure.

FIG. 7 shows a plan view of a meta-surface antenna array and feed structure according to a fourth example of the present disclosure.

FIG. 8 shows a plan view of a meta-surface antenna array and feed structure according to a fifth example of the present disclosure.

FIG. 9 shows an end-on perspective view of a thin-walled waveguide to enable the present disclosure.

FIG. 10 shows an end-on perspective view of a narrow-wall waveguide optimised for use with the present disclosure.

FIG. 11 shows simulated far-field radiation plots according to an arrangement of the second example of the present disclosure.

### DETAILED DESCRIPTION

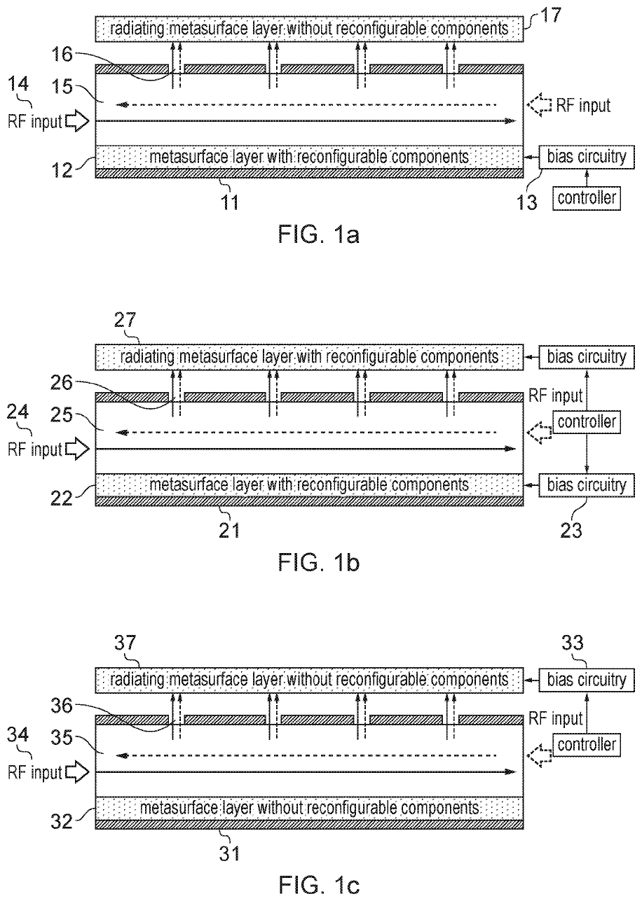

The present disclosure utilises unit cell structures in what are known as meta-surfaces. Such structures are artificial surfaces with particular properties tailored to affect particular wavelengths of electromagnetic radiation and modify certain properties of that wave in controlled ways. These surfaces can be used in conjunction with reconfigurable elements to control many aspects of the RF wave. In this case we postulate the use of similar meta-surface unit cells as proposed in the co-pending UK patent application No. 2211127.2 which describes a unit cell structures and, where appropriate, associated reconfigurable element arrangements. These arrangements in a one dimensional array form are summarised in FIGS. 1a-1c.

FIGS. 1a-1c show sectional views through three arrangements of one dimensional arrays unit cells containing a series of meta-surface unit cells and a feed waveguide structure. The structure has an RF feeding arrangement (14, 24, 34) which provides RF energy into an air-filled structure, which may be a waveguide (15, 25, 35) but could be another type of RF conductive structure. In this description we will refer to the waveguide, but this will also include other typical RF conductive structure also. The waveguide has a metallic bottom layer (11, 21, 31) and a metallic top layer. The top layer having apertures or openings (16, 26, 36) cooperating with an upper meta-surface (17, 27, 37) and a second meta-surface (12, 22, 32) on the bottom layer. In FIG. 1a the top meta-surface (17) does not contain reconfigurable components and is used to enhance the bandwidth and radiated power; only the bottom meta-surface has reconfigurable components driven by control and bias circuitry (13). FIG. 1b is a similar arrangement to 1a, however, the both meta-surfaces have reconfigurable elements (27, 22) each driven by a controller (23) and associated bias circuitry. FIG. 1c is similar to 1a in that only one meta-surface has reconfigurable elements. But in this case, it is only the top meta-surface layer (37) with reconfigurable components, the meta-surface on the bottom layer (32) is only passive.

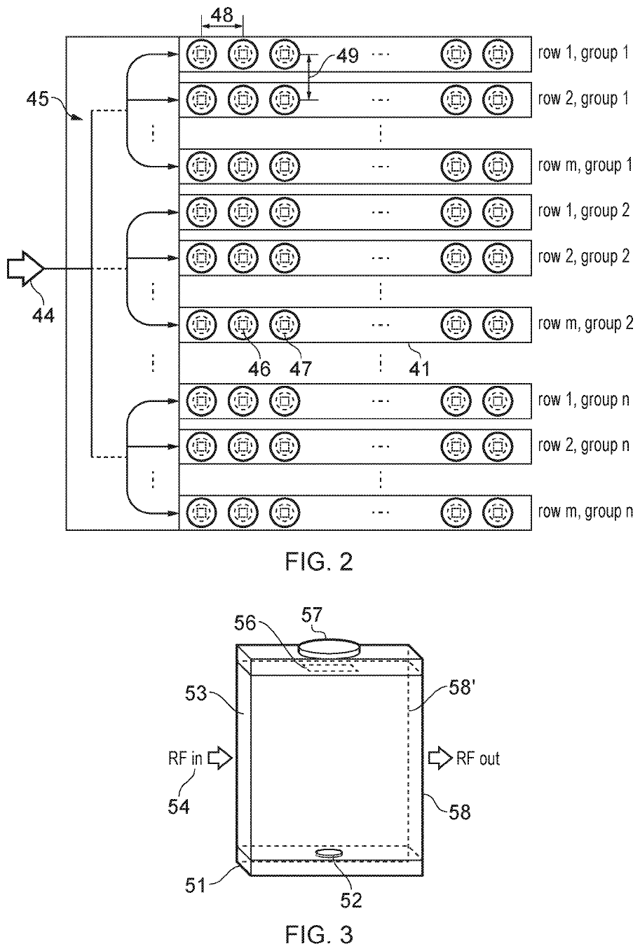

The first example of the present disclosure is summarised in FIG. 2 which shows a plan view of the proposed novel antenna array feed structure. The structure comprises an RF feed (44) feeding into an RF power distributor (45). Suitable RF power distributors are well known in the art and utilise either transmission line or waveguide type structures to divide the feed RF power between a number of output terminals with as low loss as possible; one such type is described in patent application CN103974405A.

The RF energy is then fed into a number of waveguide feed structures (41) similar to those described in FIGS. 1a-1c. Each waveguide has a linear arrangement of unit cell elements, each with a reconfigurable component (47) cooperating with a meta-surface and an aperture (46). These linear, or one dimensional arrays, can contain any number of unit cells in a series row. A number of these rows can then be fed from the output terminals of the RF distributor, creating a 2d array from the multiple one dimensional linear rows. The separation length (48) between each of the unit cells along the one dimensional row may be in the range 0.1-0.35λ₀ where λ₀ is the operating wavelength of the antenna arrangement in free space. Additional rows of one dimensional series elements are arranged such that the corresponding unit cells line up to create columns. The spacing of such unit cells between adjacent columns (49) should also be in the range 0.1-0.35λ₀. Such spacing ensures adequate spatial sampling within one wavelength and therefore improves directivity, reduces side lobes and increases radiation efficiency.

Each one dimensional series row is formed from a metallic-walled waveguide with bottom and upper layers and sidewalls. This structure can be best described in FIG. 3 which illustrates a cross-sectional view of a unit cell. The waveguide is a type known as a narrow wall waveguide as the top and bottom layers (or walls) (51) have a very narrow separation compared to the broad separation distance of the sidewalls (58, 58′). The unit cell also has the meta-surface(s) which can be positioned in the bottom layer (52), the top layer (57) above the slot (56) or in both positions. The meta-surfaces may also have reconfigurable components such as diodes or other to actively change the properties of the waveguide at that point. This operation enables effective two dimensional scanning of the far-field beam.

Narrow wall slotted waveguides are typically used in radar and communication systems due to their high-performance, low loss and high-power handling capabilities. These properties are further enhanced by the particular feeding, meta-surface and precise spacing arrangements described herein. The meta-material, cooperating with the reconfigurable elements and slots creates what is known as a holographic diffraction pattern that can steer the radiated or received wave. This phenomenon is different from the typical signal-processed phased-array beam steering.

In this example the electromagnetic energy is fed to the series narrow waveguide structures (41) through the power distributor (45). In this example all of the rows and series unit cells are driven equally. The reconfigurable elements in the unit cell structures (47) drives a radiating element in the unit cell to configure emission of electromagnetic energy with controlled phase or polarisation.

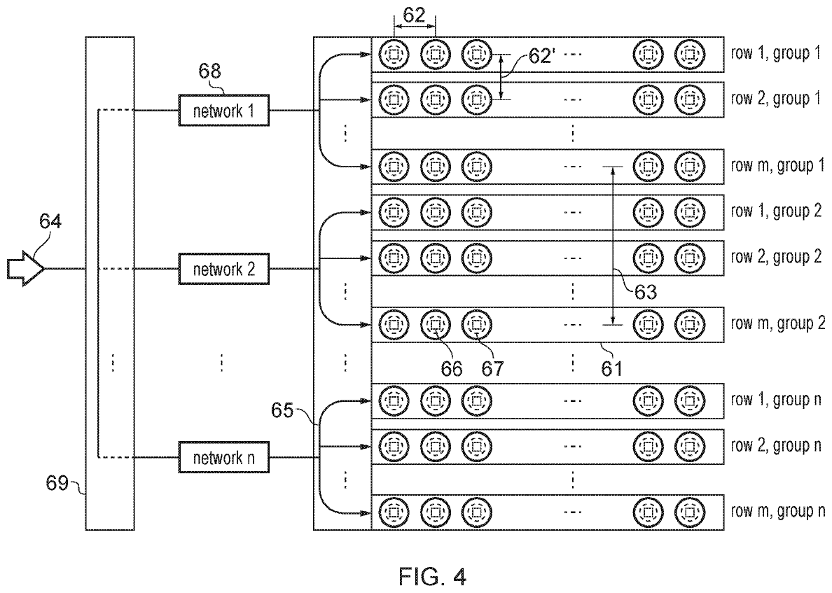

FIG. 4 shows a plan view of a second example of the array and feeding arrangements of the antenna. This is a hybrid meta-surface antenna array utilising phase shifters and holographic meta-surface unit cells to achieve beam scanning. This arrangement has an RF feed (64) which enters a first power distributor (69). Power distributors are RF components that split an incoming RF source feed using low-loss waveguides or strip lines to deliver an RF output at multiple stages in the output section. In this case the first power distributor may feed into a variation network (68) before feeding into the input stage of a second power distributor (65). The output of the second power distributor may then feed multiple rows of the series narrow waveguides (61) or group. This means that multiple rows or groups can be varied independently with the controllable variation networks to change the phase or amplitude. Beam steering along the rows is through traditional phased array via the variation networks, whereas the steering along the column direction is through the holographic meta-surface effect.

The variation networks may comprise any of, or any combinations of: phase shifter, attenuator, RF switch, power amplifier, or low-noise amplifier.

In order to optimise the operation of this array arrangement, the spacing between series unit cells along a row (62) and between rows (columns) (62′), in the same group, may be in the range 0.1-0.35λ₀ where do is the operating wavelength of the antenna arrangement in free space. Similarly, the optimal spacing between rows in adjacent antenna groups (63) may be in the range 0.4-0.75λ₀ where do is the operating wavelength of the antenna arrangement in free space. This inter-group spacing helps to reduce grating lobes and intersection, providing an optimal two dimensional beam-scanning main lobe.

It should also be appreciated that the number of rows that can be available in each group will be dictated by the separations between unit cells in a column and the adjacent cell separation between groups to remain within the acceptable performance boundaries.

This feeding arrangement allows the radiating/receiving properties of groups of rows to be changed via the feeding networks, using phased array, and the columns to be changed through the meta-surface and reconfigurable components. If each series reconfigurable element in a row, or group of rows is the same and easily manufactured, for example, a diode or LCD array, then this feeding arrangement allows for dual-band operation in the same aperture of the unit cell in a simpler structure that reduces cost and complexity.

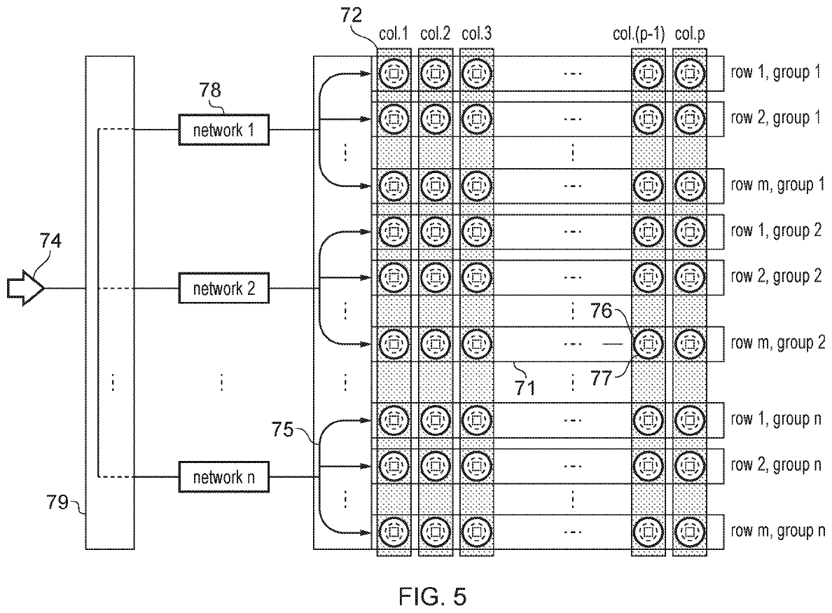

FIG. 5 shows a plan view of a third example of the present disclosure. This is also a hybrid meta-surface antenna array utilising phase shifters and holographic meta-surface unit cells to achieve beam scanning. The feeding arrangement is broadly similar to the previous, comprising an RF feed (74) going into a first power distributor (79); a series of variation networks (78) are then fed with the multiple outputs of the distributor before entering a second power distributor (75). The outputs of the second power distributor (75) form the collective groups of rows of the unit cells (77) along the narrow-wall waveguides (71). Control of the phase and/or amplitude may for each group may be controlled by the variation networks, and different from the second example, each column (72) may be controlled by the same reconfigurable element, for example LCD, RF diode, or MEMS switch, and therefore each column controlled or switched at the same time using the shared reconfigurable component. Therefore, the number of reconfigurable components may equal the number of columns, or there may be one reconfigurable component per group of rows in a column; this concept is described in more detail in the next section. This implementation further simplifies both the control and structural complexity whilst still enabling two dimensional beam steering.

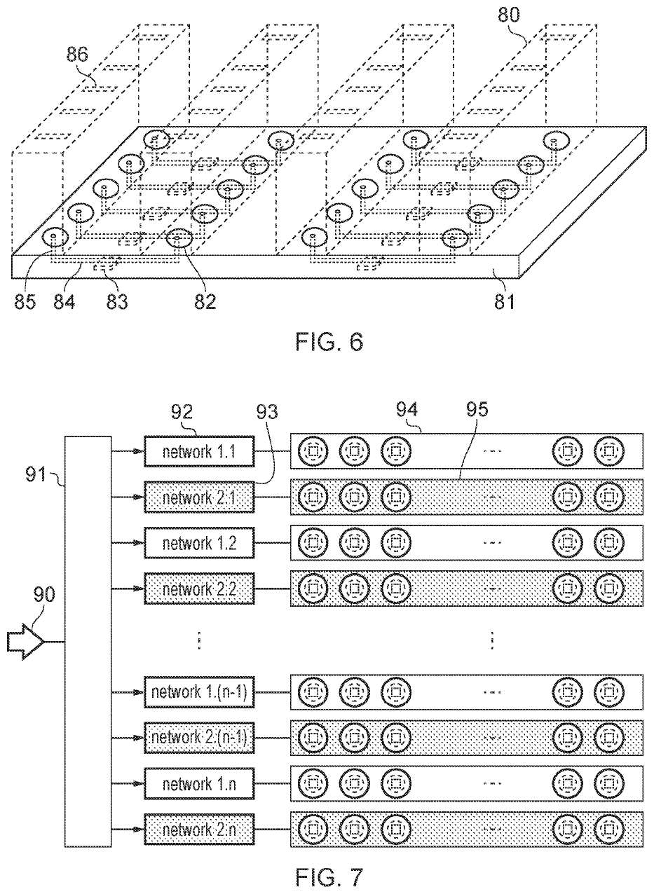

FIG. 6 shows an end-on sectional view of the series waveguides forming the rows of the third example. This example is a further structural simplification of the array whereby more than one waveguide can share a reconfigurable component. The narrow-wall waveguides (80) with slots in the top surface (86) are attached to a substrate, which may be a PCB-type board (81). The waveguides are arranged on the PCB such that the slots or apertures and the associated meta-surfaces, forming the unit cells (82) are situated at the end of the waveguide attached to the PCB layer. The PCB layer may be double-sided and support a shared reconfigurable component (83) that can alter the properties of one or more unit cells simultaneously through electrical traces (84), vias (85) and appropriate control circuitry (not shown). In this particular example one reconfigurable component is shared between two unit cells, however in some examples, this could be more, dependent on the width and spacing of the waveguides and the design costs and required performance of the antenna arrangement.

FIG. 7 shows a plan view of a meta-surface antenna array and feed structure according to a fourth example of the present disclosure. This arrangement has an RF feed (90) which enters into a power distributor (91). The power distributor delivers RF energy into multiple and different variation networks, in this case Network 1 (92) and Network 2 (93), however there may be more different networks dependent on the requirements of the antenna arrangement.

Network 1 (92) feeds RF energy with first particular phase or amplitude properties into narrow-wall waveguide structure 1 (94). Network 2 (93) feeds RF energy with second particular amplitude or phase properties into narrow-wall waveguide structure 2 (95). The Network 1 enables operation in a first frequency band, and the Network 2 enables operation in a second frequency band. Beam scanning is realised utilising the holographic (unit cell) reconfiguration and the traditional network phase-shifting or amplitude variation to enable two dimensional beam-steer.

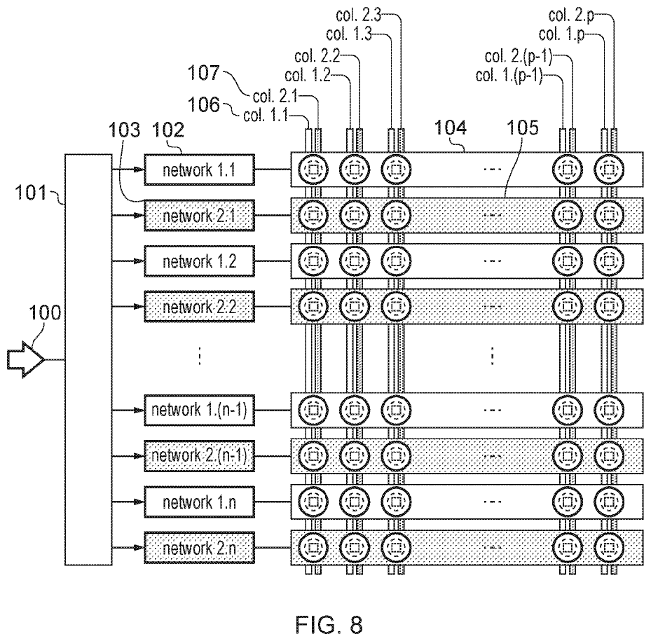

FIG. 8 shows a plan view of a hybrid meta-surface antenna array and feed structure according to a fifth example of the present disclosure. This arrangement is a variation of the fourth example, where there is an RF feed (100) into a power distributor (101); wherein the distributor feeds RF energy into a first variation network (102) and also, simultaneously, to a second variation network (103), where the variation networks feed into a first (104) and second (105) narrow-wall waveguides containing the series unit cells.

Adjustment of the phase and/or amplitude may for each group may be controlled by the variation networks in a similar way to the previous example where Network 1 (102) enables operation in a first frequency band along the length of the waveguide, and the Network 2 (103) enables operation in a second frequency band. Each column may be controlled by the same reconfigurable element, for example LCD, RF diode, or MEMs, and therefore each column controlled or switched at the same time using the shared reconfigurable component. Therefore, the number of reconfigurable components may equal the number of columns, or there may be one reconfigurable component per group of rows in a column. In this particular dual-band case there is a control line for addressing a first set of reconfigurable components (106) associated with a first frequency band; and another line for addressing a second set of reconfigurable components (107) associated with a second frequency band. The design simplifies the dual-band operation by utilising the holographic meta-surface technique for scanning along the axis of the waveguides and traditional phasing for scanning across the across the axis of the waveguides, all operating in two separate frequency bands.

The arrangement significantly reduces the cost as the number of reconfigurable components is reduced and also the complexity as the variation networks are tailored for each band and discrete, therefore can be simpler in design.

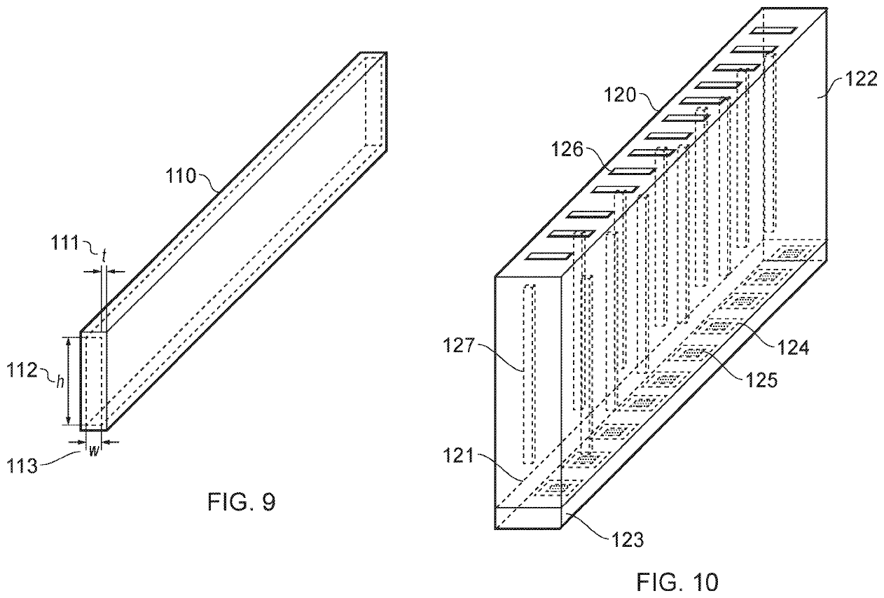

FIG. 9 shows a more detailed view of the dimensions of the narrow-wall waveguides that are used to enable the present disclosure. The end-on perspective view shows the narrow-wall waveguide (110) that is air-filled for low-loss, which comprises metallic sidewalls and top and bottom layers. The waveguide can be manufactured from folded metal, metallic coated elements, or layers in a multiplayer circuit board, or other suitable technologies for producing structural metallic wall elements. The key parameters for the design and efficient operation of the waveguide structure for the purposes of this disclosure are: the sidewall height (112, h), and the width of the air-filled channel created by the waveguide (113, w′).

The height of the optimal waveguide design may be:

$$\frac{0.75 c}{f} < h < \frac{1.15 c}{f}$$

The width of the channel should optimally be:

$$w < \frac{c}{2 f} \frac{1}{\sqrt{1 - {( \frac{c}{2 hf} )}^{2}}}$$

Where c is the speed of light in free space, and f is the centre operating frequency.

The thickness of the sidewalls (111, t) is mainly governed by the manufacture technique i.e. coating versus metal and also by the required spacing between adjacent waveguides in the two dimensional array.

FIG. 10 shows an example of a narrow-wall waveguide that is optimised for operation in beam-steering according to the present disclosure. The optimised waveguide arrangement (120) comprises metallic top and side walls (121), with slots in the top surface (126). The bottom surface may comprise a structure element such as a printed circuit board (123) and has the meta-surface unit cell elements (124) arranged on it with associated reconfigurable elements (125). The waveguide is air-filled (122) to reduce losses.

As in previous examples the unit cell cooperates with the top slot to provide phase and amplitude adjustments to the RF energy travelling in the waveguide. This effect over multiple unit cell sites allows beam-steering. The main additional features of this optimised arrangement are the serration type slots (127) that are created in the sidewalls of the waveguide. The RF energy in the form of a travelling wave contained in the waveguide is what is adjusted using the meta-surface unit cells, however, the effects of changes from the cells on the wave can be more efficient and more pronounced if the travelling wave is slowed down. The serrations are both slots and puncture into the waveguide structure as well, this arrangement helps to slow the travelling wave.

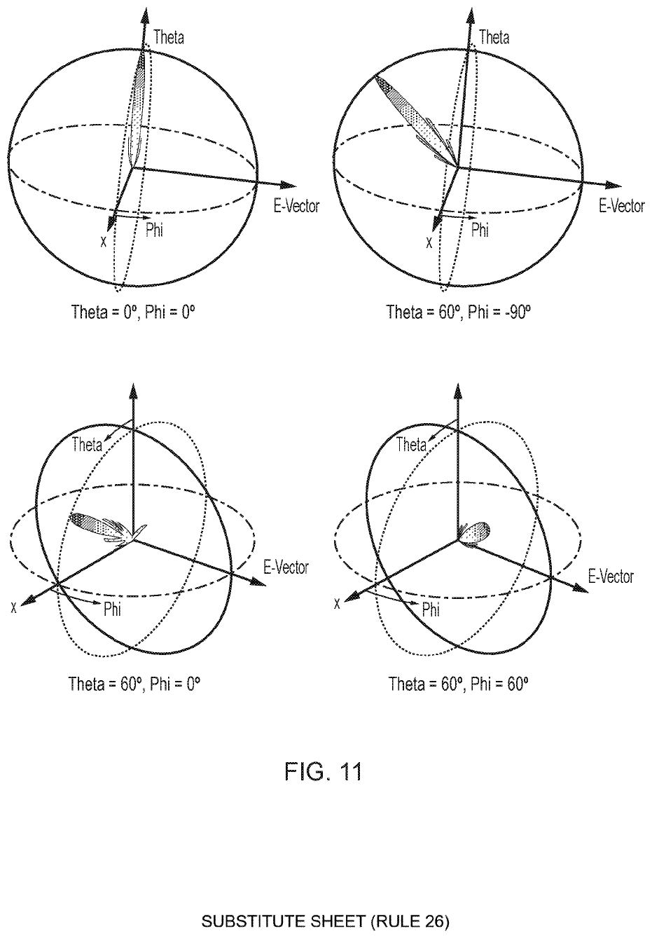

FIG. 11 shows simulated far-field radiation plots from an arrangement of the second example of the present disclosure. This example simplified the feeding arrangement by using biasing networks to control phase and/or amplitude in the waveguide rows, and the reconfigurable holographic effect via the unit cell in the column direction, in what we deem a hybrid arrangement. The simulation clearly shows that the arrangement is capable of steering a very focused beam of RF radiation, in this case at 14 GHz and sweeping a range of states in the upper hemisphere of the plot between end-fire and various angles towards broadside, rotating around the array centre-point. It should be noted that the other examples have similar plots and are equally capable of the steering the beam in the noted ranges.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing examples. The disclosure extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A reconfigurable antenna array comprising:
a radio frequency, RF, feed, configured to receive RF signals from an RF source;
a plurality of waveguide feed structures, each waveguide feed structure comprising a plurality of unit cells arranged end-to-end, each unit cell configured to transmit RF signals out of the unit cell; and
an RF power distributor, operatively connected to said RF feed, configured to split the received RF signals into multiple channels and to allocate different channels to different respective waveguide feed structures, wherein each waveguide feed structure is configured to guide the RF signals of the channel allocated to the waveguide structure to the unit cells of the waveguide feed structure;
wherein each unit cell comprises reconfigurable components configured to manipulate electromagnetic properties of the RF signals received by the RF feed and guided along the respective waveguide structure so as to control a radiation pattern of the antenna array.

2. The reconfigurable antenna array of claim 1, further comprising at least one variation network between the RF feed and the plurality of waveguide feed structures, wherein adjustment of the at least one variation network modifies properties of the RF signals so as to provide further control of the radiation pattern of the antenna array.

3. The reconfigurable antenna array of claim 1, further comprising a plurality of parallel variation networks between the RF feed and the plurality of waveguide feed structures, wherein adjustment of the variation networks modifies properties of the RF signals so as to provide further control of the radiation pattern of the antenna array.

4. The reconfigurable antenna array of claim 2, wherein the each at least one variation network is configurable to change a phase, or an amplitude, or both a phase and an amplitude, of an RF signal passing therethrough.

5. The reconfigurable antenna array of claim 2, wherein the at least one variation network comprises at least one component selected from: phase shifters, attenuators, RF switches, power amplifiers, low-noise amplifiers and combinations thereof.

6. The reconfigurable antenna array of claim 3, further comprising an additional RF power distributor, operatively connected between the RF feed and the plurality of parallel variation networks, configured to split the received RF signals into multiple channels and to allocate different channels to different respective variation networks of the plurality of parallel variation networks.

7. The reconfigurable antenna array of claim 3, wherein each waveguide feed structure is connected to a respective one of the plurality of parallel variation networks.

8. The reconfigurable antenna array of claim 1, wherein each waveguide feed structure comprises a metallic base wall and a metallic top wall substantially parallel to the base wall, and provided with a periodic pattern of apertures, the waveguide feed structure defining a substantially linear cavity with first and second ends.

9. The reconfigurable antenna array of claim 8, wherein each waveguide feed structure further comprises first and second substantially parallel metallic side walls that are disposed substantially perpendicular to the base wall and the top wall.

10. The reconfigurable antenna array of claim 9, wherein the first and second substantially parallel metallic side walls have a height, h, and a mutual separation distance, d, and wherein h>d, optionally h>2d, optionally h>3d, optionally h>4d.

11. The reconfigurable antenna array of claim 10, wherein each waveguide feed structure is configured as a narrow wall waveguide feed structure.

12. The reconfigurable antenna array of claim 8, wherein the unit cells are configured to transmit RF signals through the apertures.

13. The reconfigurable antenna array of claim 8, wherein the reconfigurable components of the unit cells are in an upper electromagnetic metasurface layer disposed above the metallic top wall.

14. The reconfigurable antenna array of claim 8, wherein the reconfigurable components of the unit cells are in a lower electromagnetic metasurface layer disposed on or adjacent to the metallic base wall.

15. The reconfigurable antenna array of claim 8, wherein the reconfigurable components of the unit cells are in both an upper electromagnetic metasurface layer disposed above the metallic top wall and in a lower electromagnetic metasurface layer disposed on or adjacent to the metallic base wall.

16. The reconfigurable antenna array of claim 1, wherein the reconfigurable components of the unit cells comprise at least one of switchable conductive patches, switchable slots, microelectromechanical (MEMS) elements, nanoelectromechanical (NEMS) elements, chiral change elements, or liquid crystal elements.

17. The reconfigurable antenna array of claim 1, wherein the reconfigurable components are configured to be switchable between at least a first state and a second state, the first state interacting with and modifying the RF signals differently to the second state.

18. The reconfigurable antenna array of claim 1, wherein the waveguide feed structures are arranged substantially parallel to each other so as to define a two dimensional array of unit cells arranged in rows and columns.

19. The reconfigurable antenna array of claim 18, wherein the reconfigurable components of each unit cell are controllably addressable by row, or by column, or by both row and column.

20. The reconfigurable antenna array of claim 18, wherein adjacent waveguide feed structures are fed with RF signals in different frequency bands.
